(19) United States
(12) Patent Application Publication
(10) Pub. No.: US 2024/0391844 A1
(43) Pub. Date: Nov. 28, 2024

(54) PREPARATION METHOD AND USE OF DIATOM-BACTERIUM SYMBIOTIC ORGANIC LIQUID FERTILIZER

(71) Applicants: Tianjin Yufeng Technology Co., Ltd., Tianjin (CN); Tianjin University, Tianjin (CN)

(72) Inventors: Hui Ding, Tianjin (CN); Xiangci Wu, Tianjin (CN); Chenglong Dai, Tianjin (CN); Dan Zhao, Tianjin (CN)

(21) Appl. No.: 18/674,372

(22) Filed: May 24, 2024

(30) Foreign Application Priority Data
May 26, 2023 (CN) 202310604443.0

(51) Int. Cl. C05F 17/20; C05F 3/00; C05F 5/00; C05F 17/40; C05F 17/50; C05G 5/20

(52) U.S. Cl. CPC C05F 17/20; C05F 3/00; C05F 5/004; C05F 17/40; C05F 17/50; C05G 5/20

(57) ABSTRACT

The application provides a preparation method and use of a diatom-bacterium symbiotic organic liquid fertilizer, and belongs to the technical field of biological fertilizers. The preparation method of the diatom-bacterium symbiotic organic liquid fertilizer includes the following steps: (1) mixing a compound bacterial powder with a waste liquid organic matter to allow first fermentation to obtain a small-molecule organic liquid fertilizer; (2) mixing diatom with the small-molecule organic liquid fertilizer to allow second fermentation to obtain a bio-organic fertilizer; and (3) mixing a microbial inoculant with the bio-organic fertilizer to allow third fermentation to obtain the diatom-bacterium symbiotic organic liquid fertilizer. In the application, the diatom-bacterium symbiotic organic liquid fertilizer prepared by the preparation method is used for soil improvement. The organic liquid fertilizer can not only effectively improve soil, enhance fertilizer utilization, and increase crop yield and quality, but also can achieve resource utilization of waste.

### CROSS REFERENCE TO RELATED APPLICATION

This patent application claims the benefit and priority of Chinese Patent Application No. 202310604443.0, filed with the China National Intellectual Property Administration on May 26, 2023, the disclosure of which is incorporated by reference herein in its entirety as part of the present application.

### TECHNICAL FIELD

The present disclosure relates to the technical field of biological fertilizers, and in particular to a preparation method and use of a diatom-bacterium symbiotic organic liquid fertilizer.

### BACKGROUND

Long-term use of chemical fertilizers causes soil fertility to decrease, causing soil hardening, acidification, and salinization. These phenomena lead to a decrease in soil organic matter, an increase in heavy metals in the soil, and a decrease in the total amount and activity of beneficial microbial flora in crop roots, thereby seriously affecting the normal growth of crops. High-efficiency organic fertilizer alternatives and actions for fertilizer reduction have been elevated to the national policy level. It is of far-reaching significance to explore an efficient green organic fertilizer that is widely used in crops.

Diatom is a single-celled algae belonging to the Bacillariophyceae of the Heterokontophyta, with many species and wide distribution. The diatom is rich in proteins, amino acids, inorganic salts, vitamins, and algin, and contains a small amount of physiologically-active substances such as enzymes, plant hormones, polyphenols, and polysaccharides. After biochemical treatment, the diatom can be prepared into green organic fertilizer, which has broad development prospects.

Traditional diatom fertilizer technology rarely combines the co-cultivation with bacterial strains, and shows difficulty in both algae-water separation and storage/transportation, poor stability of the treatment process, substandard purification effect, high production cost, and low fertilizer efficiency.

### SUMMARY

An objective of the present disclosure is to provide a preparation method and use of a diatom-bacterium symbiotic organic liquid fertilizer, thus solving the problems existing in the prior art.

To achieve the above objective, the present disclosure provides the following technical solutions:

A first technical solution of the present disclosure provides a preparation method of a diatom-bacterium symbiotic organic liquid fertilizer, including the following steps:
(1) mixing a compound bacterial powder with a waste liquid organic matter to allow first fermentation to obtain a small-molecule organic liquid fertilizer;
(2) mixing diatom with the small-molecule organic liquid fertilizer to allow second fermentation to obtain a bio-organic fertilizer; and
(3) mixing a microbial inoculant with the bio-organic fertilizer to allow third fermentation to obtain the diatom-bacterium symbiotic organic liquid fertilizer.

Further, the compound bacterial powder includes Thiobacillus denitrificans, Bacillus megaterium, Alcaligenes faecalis, and Issatchenkia orientalis, and the waste liquid organic matter is selected from the group consisting of sewage separated from livestock and poultry manure, fruit and vegetable pressing wastewater, and vegetable waste pressing wastewater in step (1).

Further, indicators of the sewage separated from livestock and poultry manure are: a chemical oxygen demand (COD) of 3,000 mg/L to 3,500 mg/L, a total phosphorus content (TP) of 100 mg/L to 200 mg/L, an ammonia nitrogen content (NH₃—N) of 500 mg/L to 700 mg/L, and a five-day biological oxygen demand (BOD₅)/CODcr ratio of 0.6 to 0.7. The sewage separated from livestock and poultry manure contains a large amount of nutritional pollutants and is highly biodegradable.

Further, the fruit and vegetable pressing wastewater is wastewater discharged from fruits and vegetables after washing, crushing, and pressing processes, the vegetable waste pressing wastewater is wastewater discharged from vegetable waste after washing, crushing, and pressing processes; and

Further, indicators of the fruit and vegetable pressing wastewater or the vegetable waste pressing wastewater are: a COD of 8,000 mg/L to 15,000 mg/L, a BOD₅ of 3,000 mg/L to 4,500 mg/L, a suspended solid concentration (SS) of 600 mg/L to 800 mg/L, and a pH value of 6 to 8.

Further, the compound bacterial powder and the waste liquid organic matter are at a mass ratio of (1-3):(48-65), and the Thiobacillus denitrificans, the Bacillus megaterium, the Alcaligenes faecalis, and the Issatchenkia orientalis are at a mass ratio of (10-15):(6-8):(8-10):(1-3) in step (1).

Further, the diatom and the small-molecule organic liquid fertilizer in step (2) are at a mass ratio of (1-3):(55-75).

Further, the diatom in step (2) is common Navicula.

Further, the microbial inoculant in step (3) includes Bacillus amyloliquefaciens, Brevibacillus laterosporus, and Streptomyces microflavus.

Further, the microbial inoculant and the bio-organic fertilizer are at a mass ratio of (1-3):(62-84), and the Bacillus amyloliquefaciens, the Brevibacillus laterosporus, and the Streptomyces microflavus in the microbial inoculant are at a mass ratio of (8-11):(7-10):(2-4) in step (3).

Further, the first fermentation in step (1) is conducted with a pH value of 6.8 to 7.2 at 25° C. to 35° C. for 48 h to 96 h; the second fermentation in step (2) is conducted with a light intensity of 1,500 lux to 2,500 lux at 25° C. to 30° C. for 96 h to 128 h; and the third fermentation in step (3) is conducted at 25° C. to 35° C. for 24 h to 72 h.

A second technical solution of the present disclosure provides a diatom-bacterium symbiotic liquid fertilizer prepared by the preparation method.

A third technical solution of the present disclosure provides use of the diatom-bacterium symbiotic liquid fertilizer in soil improvement.

Further, the diatom-bacterium symbiotic liquid fertilizer is sprayed into soil at a dosage of 15,000 mL/hm² once.

Further, the diatom-bacterium symbiotic liquid fertilizer is diluted 800 times with water and then sprayed.

Further, the soil is selected from the group consisting of soil contaminated by the sewage separated from livestock and poultry manure, the fruit and vegetable pressing wastewater, or the vegetable waste pressing wastewater and nutrient-deficient soil.

The present disclosure has the following technical effects:

(1) In the present disclosure, the diatom-bacterium symbiotic liquid fertilizer contains a large amount of diatoms and a variety of microorganisms. The diatoms and various microorganisms can form dominant populations around the roots of crops, inhibiting the life activities of other harmful bacteria and effectively improving the soil. O₂ produced during photosynthesis of the diatoms can well supply the metabolic activities of beneficial bacteria, and CO₂ quorum-sensing signal molecules produced by the beneficial bacteria can promote the assimilation and growth of microalgae. The above two mechanisms work together to decompose insoluble phosphorus and potassium fertilizers in the soil and produce a variety of substances needed by plants, such as small-molecule amino acids, growth-promoting hormones, and vitamins. During the fermentation, the bacteria decompose the waste liquid organic matter and convert same into small molecular substances, providing carbon and nitrogen sources for the growth of diatoms and beneficial bacteria, thereby realizing the reuse of waste resources.

(2) In the present disclosure, the diatom-bacterium symbiotic organic liquid fertilizer has the functions of fixating nitrogen, decomposing phosphorus, and decomposing potassium, thereby reducing the use of chemical fertilizers. This fertilizer can also form dominant populations around the roots of crops, inhibiting the life activities of other harmful bacteria. Root irrigation with this fertilizer can inhibit pathogenic bacteria in the soil while foliar spraying of this fertilizer can prevent the invasion of diseases, so as to achieve biological control of diseases. The diatom-bacterium symbiotic organic liquid fertilizer is used for soil improvement and can enhance fertilizer utilization, increase crop yield and quality, and achieve resource utilization of waste.

(3) In the present disclosure, the various bacterial strains can synergistically cooperate after being combined in a specific proportion range to effectively decompose the waste liquid organic matter, so as to obtain small-molecular organic matters. Moreover, there is no antagonistic effect between the various bacterial strains. Meanwhile, the bacterial strains exhibit desirable nitrogen-fixing and carbon-sequestrating effects, and their application in planting can greatly increase crop yields.

(4) In the present disclosure, the diatom-bacterium symbiotic liquid fertilizer is produced through three fermentation processes. The compound bacterial powder and the waste liquid organic matter are mixed to allow first fermentation. In the first fermentation, the compound bacterial powder decomposes macromolecular organic substances, organic sulfides, and organic nitrogen that can produce malodorous gases in the waste liquid organic matter, to produce a small-molecule organic liquid fertilizer. The diatom and the small-molecule organic liquid fertilizer are mixed to allow second fermentation. In the second fermentation, the small-molecule organic liquid fertilizer provides the diatom with C, N, S and other nutrients required for growth, such that the diatom can be expanded to produce a bio-organic fertilizer. The microbial inoculant and the bio-organic fertilizer are mixed to allow third fermentation. In the third fermentation, the bio-organic fertilizer provides nutrients required for the growth and reproduction of the microbial inoculant, and the diatom-bacterium symbiotic organic liquid fertilizer is produced in synergy. The three fermentation processes have a synergistic effect, which not only efficiently degrades the waste liquid organic matter, but also provides sufficient acclimation time and nutrients for the compound bacterial powder, diatom, and microbial inoculant.

### DETAILED DESCRIPTION OF THE EMBODIMENTS

Some exemplary embodiments of the present disclosure are now described in detail. The detailed description should not be considered as a limitation to the present disclosure, but should be understood as a more detailed description of certain aspects, features, and implement solutions of the present disclosure.

It should be understood that terms described in the present disclosure are merely used to describe specific embodiments and are not intended to limit the present disclosure. In addition, for a numerical range in the present disclosure, it should be understood that each intermediate value between an upper limit and a lower limit of the range is also specifically disclosed. Each smaller range between any stated value or intermediate value in a stated range and any other stated value or intermediate value in the stated range is also included in the present disclosure. The upper and lower limits of these smaller ranges can independently be included or excluded from the range.

Unless otherwise stated, all technical and scientific terms used herein have the same meaning as commonly understood by those of ordinary skill in the art described in the present disclosure. Although the present disclosure describes only preferred methods and materials, any methods and materials similar or equivalent to those described herein can also be used in the practice or testing of the present disclosure. All documents mentioned in this specification are incorporated by reference to disclose and describe methods and/or materials related to the documents. In case of conflict with any incorporated documents, the content of this specification shall prevail.

It is obvious to a person skilled in the art that a plurality of modifications and variations can be made to the specific embodiments of the present specification without departing from the scope or spirit of the present disclosure. Other embodiments derived from the description of the present disclosure are obvious to a person skilled in the art. The specification and embodiments of the present application are merely exemplary.

As used herein, “including”, “having”, “containing”, and the like are all open-ended terms, which means including but not limited to.

In the following examples and comparative examples, the Thiobacillus denitrificans is purchased from the Sichuan Center Of Industrial Culture Collection (SICC), with a deposit number of SICC BIOMA 32; the Bacillus megaterium is purchased from the China Center For Type Culture Collection (CCTCC), with a deposit number of CCTCC AB 207465; the Alcaligenes faecalis is purchased from the China Center of Industrial Culture Collection (CICC), with a deposit number of CICC 23647; the Issatchenkia orientalis is purchased from the CICC, with a deposit number of CICC 1972; the Bacillus amyloliquefaciens is purchased from the China General Microbiological Culture Collection Center (CGMCC), with a deposit number of CGMCC 1.1603; the Brevibacillus laterosporus is purchased from the CCTCC, with a deposit number of CCTCC CB 20082249; and the Streptomyces microflavus is purchased from the CGMCC, with a deposit number of CGMCC 4.2024.

In the following examples and comparative examples, the waste liquid organic matter is selected from the group consisting of sewage separated from livestock and poultry manure, fruit and vegetable pressing wastewater, and vegetable waste pressing wastewater.

The sewage separated from livestock and poultry manure is sewage obtained by solid-liquid separation of livestock and poultry manure in a certain breeding farm, with indicators including: a COD of 3,300 mg/L, a TP of 150 mg/L, an NH₃—N of 600 mg/L, and a BOD₅/CODcr ratio of 0.65; and

the vegetable waste pressing wastewater is wastewater discharged from washing, crushing, and pressing processes of a food processing plant, with indicators including: a COD of 10,000 mg/L, a BOD₅ of 3,700 mg/L, an SS of 700 mg/L, and a pH value of 7.2.

### Example 1

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:48 to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 10:6:8:1.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Example 2

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:48 to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 10:6:8:1.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 2:75 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio 10:8:3.

The waste liquid organic matter in step (1) adopted sewage separated from livestock and poultry manure and vegetable waste pressing wastewater to obtain two parts of the diatom-bacterium symbiotic organic liquid fertilizer, respectively.

### Example 3

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 2:57 to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 13:7:9:2.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Example 4

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 2:57 to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 13:7:9:2.

### (2) Preparation of a Bio-Organic Fertilizer

Navicula diatom and the small-molecule organic liquid fertilizer were mixed at a mass ratio of 2:63 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Example 5

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:48 to allow first fermentation in a fermentation barrel with a pH value of 6.8 at 25° C. for 96 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 10:6:8:1.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 1,500 lux at 25° C. for 128 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 24 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Example 6

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:48 to allow first fermentation in a fermentation barrel with a pH value of 7.2 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 10:6:8:1.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 2,500 lux at 30° C. for 96 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 24 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Comparative Example 1

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:70 to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 7:10:5:4.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Comparative Example 2

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:15 to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 17:4:13:1.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Comparative Example 3

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:48 to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 10:6:8:1.

### (2) Preparation of a Bio-Organic Fertilizer

Navicula diatom and the small-molecule organic liquid fertilizer were mixed at a mass ratio of 1:80 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 3:55 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Comparative Example 4

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:48 AM to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 17:4:13:1.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Comparative Example 5

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:15 AM to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 10:6:8:1.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Comparative Example 6

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:48 to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 10:6:8:1.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 7:6:5.

The waste liquid organic matter in step (1) adopted sewage separated from livestock and poultry manure and vegetable waste pressing wastewater to obtain two parts of the diatom-bacterium symbiotic organic liquid fertilizer, respectively.

### Comparative Example 7

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:48 to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, and Alcaligenes faecalis that were mixed in a mass ratio of 10:6:8.

### (2) Preparation of a Bio-Organic Fertilizer

Navicula diatom and the small-molecule organic liquid fertilizer were mixed at a mass ratio of 1:55 to allow second fermentation in the fermentation barrel with a light intensity of 2,000 lux at 28° C. for 120 h to obtain the bio-organic fertilizer.

### (3) Preparation of the Diatom-Bacterium Symbiotic Organic Liquid Fertilizer

A microbial inoculant was mixed with the bio-organic fertilizer at a mass ratio of 1:62 to allow third fermentation in the fermentation barrel at 35° C. for 48 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Comparative Example 8

A preparation method of a diatom-bacterium symbiotic organic liquid fertilizer included the following steps:

### (1) Preparation of a Small-Molecule Organic Liquid Fertilizer

A compound bacterial powder and a waste liquid organic matter were mixed at a mass ratio of 1:48 to allow first fermentation in a fermentation barrel with a pH value of 7.0 at 35° C. for 48 h to obtain the small-molecule organic liquid fertilizer; where the compound bacterial powder was prepared from Thiobacillus denitrificans, Bacillus megaterium, Alcaligenes faecalis, and Issatchenkia orientalis that were mixed in a mass ratio of 10:6:8:1.

### (2) Preparation of the Diatom-Bacterium Symbiotic Organic Liquid Fertilizer

Navicula diatom and the small-molecule organic liquid fertilizer were mixed at a mass ratio of 1:55, and a microbial inoculant was added (where a mass of the microbial inoculant and a total mass of the Navicula diatom and the small-molecule organic liquid fertilizer were at a ratio of 1:62) to allow second fermentation in the fermentation barrel with a light intensity of 2,000 lux at 28° C. for 120 h to obtain the diatom-bacterium symbiotic organic liquid fertilizer; where the microbial inoculant was prepared from Bacillus amyloliquefaciens, Brevibacillus laterosporus, and Streptomyces microflavus that were mixed in a mass ratio of 8:7:2.

The waste liquid organic matter in step (1) adopted sewage separated from livestock and poultry manure and vegetable waste pressing wastewater to obtain two parts of the diatom-bacterium symbiotic organic liquid fertilizer, respectively.

### Use Example 1

Land with uniform soil mass and lack of nutrients was selected and divided into 30 plots, each with an area of 1 mu. These plots were named blank groups 1 and 2, experimental groups 1-1, 1-2, 2-1, 2-2, 3-1, 3-2, 4-1, 4-2, 5-1, 5-2, 6-1, 6-2, and control groups 1-1, 1-2, 2-1, 2-2, 3-1, 3-2, 4-1, 4-2, 5-1, 5-2, 6-1, 6-2, 7-1, 7-2, 8-1, and 8-2. The diatom-bacterium symbiotic organic liquid fertilizers prepared in Examples 1 to 6 and Comparative Examples 1 to 8 were separately applied to the soil of experimental groups 1 to 6 and the control groups 1 to 8, respectively. Among them, the X-1 groups used diatom-bacterium symbiotic organic liquid fertilizer prepared by using sewage separated from livestock and poultry manure as a waste liquid organic matter, while the X-2 group used diatom-bacterium symbiotic organic liquid fertilizer prepared by using vegetable waste pressing wastewater as a waste liquid organic matter. A same fertilization mode (conventional spraying with a 16-type electric sprayer, the diatom-bacterium symbiotic organic liquid fertilizer was applied at 15,000 mL/hm², and diluted with 800 times of water before spraying) and a management mode (conventional management method) were adopted, while the blank group did not apply the diatom-bacterium symbiotic organic liquid fertilizer. Land with uniform soil mass and normal nutrition was selected in the close area, and 2 plots were divided, each with an area of 1 mu, and were named control group 1 and control group 2, respectively. The control groups did not apply the diatom-bacterium symbiotic organic liquid fertilizer, and had a management mode the same as that of the experimental groups. The comparison of soil physical and chemical properties in nutrient-deficient land (average value of 30 plots) and land with normal nutrition (average value of control groups 1 and 2) was shown in Table 1:

TABLE 1
Soil physical and chemical properties of nutrient-
deficient land and land with normal nutrition

| | | | Alkali- | | |
|---|---|---|---|---|---|
| | | Organic | hydrolyzable | Available | Quick-acting |
| | | matter | nitrogen | phosphorus | potassium |
| Treatment | pH | (g/kg) | (mg/kg) | (mg/kg) | (mg/kg) |
| Normal soil | 7.1 | 110 | 342 | 19.5 | 150 |
| Nutrient- | 6.24 | 47.5 | 179 | 4.7 | 44 |
| deficient soil | | | | | |

A rice planting experiment (variety Yongyou 4149) was conducted in the 32 divided plots separately, and the diatom-bacterium symbiotic organic liquid fertilizer was used to improve the soil. Specifically, the fertilizer was sprayed into the soil for planting rice during a tillering stage, and economic traits of the rice were measured after 30 d of growth. The measurement results were shown in Table 2.

TABLE 2
Effects of spraying diatom-bacterium symbiotic organic liquid
fertilizer on rice economic traits in nutrient-deficient soil

| | Plant | Ear | Number of | Seed | Thousand- | Actual |
|---|---|---|---|---|---|---|
| | height | length | productive ears | set | grain weight | output |
| | (cm) | (cm) | (ears/m²) | (%) | (g) | (kg/hm²) |
| Control group 1 | 112.6 | 23.2 | 185 | 80.4 | 23.7 | 6805.2 |
| Control group 2 | 114 | 23.6 | 184 | 80.7 | 23.1 | 6811.9 |
| Blank group 1 | 110.1 | 21.4 | 181.5 | 81.2 | 23.4 | 6555.1 |
| Blank group 2 | 109.2 | 20.0 | 179.7 | 80.1 | 23.1 | 6403.2 |
| Experimental group 1-1 | 113.7 | 22.7 | 201 | 85.6 | 25.6 | 7643.8 |
| Experimental group 1-2 | 114.2 | 22.9 | 204 | 87.4 | 24.4 | 7603.8 |
| Experimental group 2-1 | 106.8 | 21.6 | 193.5 | 87.4 | 25.2 | 8592.5 |
| Experimental group 2-2 | 115.5 | 23.3 | 212 | 88.4 | 24.9 | 8577.6 |
| Experimental group 3-1 | 108.8 | 21.6 | 248 | 91.8 | 24.8 | 8987.4 |
| Experimental group 3-2 | 116.4 | 23.6 | 214.7 | 90.0 | 25.3 | 8724.4 |
| Experimental group 4-1 | 119.1 | 24.5 | 248 | 91.8 | 25.6 | 9364.7 |
| Experimental group 4-2 | 108.3 | 21.6 | 248 | 89.1 | 24.8 | 9084.5 |
| Experimental group 5-1 | 115.1 | 23.1 | 208.5 | 88.2 | 24.7 | 8084.0 |
| Experimental group 5-2 | 106.8 | 21.6 | 193.5 | 87.4 | 24.4 | 7924.0 |
| Experimental group 6-1 | 114.6 | 23.0 | 206.3 | 88.0 | 24.6 | 7964.0 |
| Experimental group 6-2 | 115.5 | 24.2 | 204 | 90.0 | 24.9 | 7942.0 |
| Control group 1-1 | 109.8 | 20.9 | 189.5 | 82.3 | 23.7 | 6883.4 |
| Control group 1-2 | 119.1 | 22.9 | 184 | 85.5 | 23.1 | 6803.4 |
| Control group 2-1 | 114.0 | 22.7 | 201.9 | 86.7 | 24.3 | 7483.7 |
| Control group 2-2 | 114.2 | 23.5 | 210 | 86.7 | 23.0 | 7243.1 |
| Control group 3-1 | 109.7 | 20.6 | 184 | 81.7 | 23.4 | 6683.3 |
| Control group 3-2 | 119.1 | 22.9 | 184 | 85.5 | 23.1 | 6403.2 |
| Control group 4-1 | 113.5 | 22.2 | 195.7 | 85.2 | 24.3 | 7219.4 |
| Control group 4-2 | 111.1 | 23.3 | 165 | 86.4 | 24.4 | 6923.5 |
| Control group 5-1 | 114.2 | 22.5 | 199.8 | 85.9 | 24.5 | 7332.7 |
| Control group 5-2 | 111.7 | 21.7 | 189 | 83.4 | 24.9 | 7023.2 |
| Control group 6-1 | 111.6 | 21.3 | 192.5 | 83.4 | 23.8 | 7114.5 |
| Control group 6-2 | 111.5 | 22.8 | 179 | 85.9 | 24.5 | 7032.0 |
| Control group 7-1 | 112.8 | 21.9 | 194.4 | 84.1 | 23.9 | 7000.5 |
| Control group 7-2 | 112.6 | 22.3 | 190 | 85.6 | 23.7 | 6883.4 |
| Control group 8-1 | 110.1 | 20.2 | 182.7 | 80.4 | 23.2 | 6579.2 |
| Control group 8-2 | 114.6 | 23.6 | 179.7 | 84.3 | 23.4 | 6604.3 |

As shown in Table 2, the diatom-bacterium symbiotic organic liquid fertilizer prepared by the present disclosure could improve the nutrient-deficient soil to significantly increase rice yield. Moreover, the diatom-bacterium symbiotic organic liquid fertilizer could achieve such desirable results due to the synergistic cooperation of various parameters in the preparation method. If any parameter was changed, there might be a greatly reduced efficacy of the diatom-bacterium symbiotic organic liquid fertilizer.

### Use Example 2

Land with uniform soil mass and contaminated by sewage separated from livestock and poultry manure was selected and divided into 30 plots, each with an area of 1 mu. These plots were named blank groups 1 and 2, experimental groups 1-1, 1-2, 2-1, 2-2, 3-1, 3-2, 4-1, 4-2, 5-1, 5-2, 6-1, 6-2, and control groups 1-1, 1-2, 2-1, 2-2, 3-1, 3-2, 4-1, 4-2, 5-1, 5-2, 6-1, 6-2, 7-1, 7-2, 8-1, and 8-2. The diatom-bacterium symbiotic organic liquid fertilizers prepared in Examples 1 to 6 and Comparative Examples 1 to 8 were separately applied to the soil of experimental groups 1 to 6 and the control groups 1 to 8, respectively. Among them, the waste liquid organic matter in the X-1 group was sewage separated from livestock and poultry manure, while the waste liquid organic matter in the X-2 group was fruit, vegetable, and vegetable waste pressing wastewater. A same fertilization mode (conventional spraying with a 16-type electric sprayer, the diatom-bacterium symbiotic organic liquid fertilizer was applied at 15,000 mL/hm², and diluted with 800 times of water before spraying) and a management mode (conventional management method) were adopted, while the blank group did not apply the diatom-bacterium symbiotic organic liquid fertilizer. Normal land with uniform soil mass and no pollution was selected in the close area, and 2 plots were divided, each with an area of 1 mu, and were named control group 1 and control group 2, respectively. The control groups did not apply the diatom-bacterium symbiotic organic liquid fertilizer, and had a management mode the same as that of the experimental groups. The comparison of soil physical and chemical properties of land contaminated by sewage separated from livestock and poultry manure (average value of 30 plots) and uncontaminated normal land (average value of control groups 1 and 2) was shown in Table 3:

TABLE 3
Soil physical and chemical properties of land contaminated
by sewage separated from livestock and poultry
manure and uncontaminated normal land

| | | | Alkali- | | Quick- |
|---|---|---|---|---|---|
| | | Organic | hydrolyzable | Available | acting |
| | | matter | nitrogen | phosphorus | erbium |
| Treatment | pH | (g/kg) | (mg/kg) | (mg/kg) | (mg/kg) |
| Normal soil | 7.2 | 103 | 355 | 19.2 | 146 |
| Contaminated soil | 5.36 | 56.3 | 179 | 6.1 | 67 |

A rice planting experiment (variety Yongyou 4149) was conducted in the 32 divided plots separately, and the diatom-bacterium symbiotic organic liquid fertilizer was used to improve the soil. Specifically, the fertilizer was sprayed into the soil for planting rice during a tillering stage, and economic traits of the rice were measured after 30 d of growth. The measurement results were shown in Table 4.

TABLE 4
Effects of spraying diatom-bacterium symbiotic organic liquid
fertilizer on economic characteristics of rice in soil contaminated
by sewage separated from livestock and poultry manure

| | Plant | Panicle | Number of | Seed | Thousand- | Actual |
|---|---|---|---|---|---|---|
| | height | length | productive ears | set | grain weight | output |
| | (cm) | (cm) | (ears/m²) | (%) | (g) | (kg/hm²) |
| Control group 1 | 108.3 | 22.9 | 184 | 80.3 | 24.1 | 6824.1 |
| Control group 2 | 112.1 | 22.5 | 186.7 | 87.6 | 23.9 | 6879.6 |
| Blank group 1 | 109.1 | 23.6 | 179.7 | 84.3 | 23.4 | 6582.7 |
| Blank group 2 | 115.3 | 24.1 | 185 | 87.3 | 23.7 | 6487.3 |
| Experimental group 1-1 | 114.1 | 23.9 | 188 | 85.68 | 24.2 | 8689.0 |
| Experimental group 1-2 | 109.2 | 22.1 | 212 | 88.9 | 24.8 | 8577.6 |
| Experimental group 2-1 | 116.4 | 23.5 | 210 | 87.7 | 25.0 | 8921.2 |
| Experimental group 2-2 | 111.8 | 23.6 | 214.7 | 86.0 | 25.3 | 8822.3 |
| Experimental group 3-1 | 108.8 | 21.6 | 226 | 85.8 | 24.8 | 9084.5 |
| Experimental group 3-2 | 107.8 | 20.0 | 248 | 91.8 | 23.4 | 9024.0 |
| Experimental group 4-1 | 111.5 | 24.5 | 248 | 91.8 | 25.3 | 9576.4 |
| Experimental group 4-2 | 111.2 | 24.5 | 188 | 85.8 | 25.3 | 9377.9 |
| Experimental group 5-1 | 115.5 | 24.2 | 238 | 84.5 | 24.9 | 8862.3 |
| Experimental group 5-2 | 108.3 | 20.0 | 212 | 88.8 | 25.7 | 8683.9 |
| Experimental group 6-1 | 110.2 | 21.6 | 193.5 | 86.7 | 25.2 | 8744.2 |
| Experimental group 6-2 | 109.2 | 22.1 | 204 | 88.9 | 24.8 | 8567.7 |
| Control group 1-1 | 111.8 | 22.2 | 175 | 85.6 | 25.2 | 7683.4 |
| Control group 1-2 | 110.4 | 22.9 | 185 | 87.3 | 23.4 | 7603.8 |
| Control group 2-1 | 112.8 | 21.6 | 189.5 | 87.4 | 25.7 | 8567.7 |
| Control group 2-2 | 116.4 | 22.2 | 195.6 | 88.0 | 25.6 | 8448.2 |
| Control group 3-1 | 110.6 | 22.9 | 179 | 86.4 | 25.0 | 7427.8 |
| Control group 3-2 | 112.6 | 22.3 | 190 | 85.6 | 24.8 | 7324.6 |
| Control group 4-1 | 114.6 | 22.1 | 214.7 | 84.3 | 24.4 | 8224.9 |
| Control group 4-2 | 111.8 | 23.6 | 214.7 | 86.0 | 25.3 | 8111.5 |
| Control group 5-1 | 119.1 | 23.1 | 185 | 85.9 | 24.8 | 8384.0 |
| Control group 5-2 | 108.7 | 23.9 | 195.4 | 82.9 | 24.8 | 8277.6 |
| Control group 6-1 | 112.4 | 21.7 | 185 | 83.3 | 23.7 | 7924.0 |
| Control group 6-2 | 111.6 | 22.4 | 186.2 | 88.4 | 24.3 | 7624.9 |
| Control group 7-1 | 112.1 | 23.0 | 194.5 | 82.7 | 24.4 | 7964.0 |
| Control group 7-2 | 109.7 | 22.7 | 246 | 85.6 | 21.3 | 7803.4 |
| Control group 8-1 | 112.4 | 22.8 | 184 | 80.1 | 23.4 | 7285.8 |
| Control group 8-2 | 107 | 21.5 | 191.7 | 87 | 23.2 | 6840.3 |

As shown in Table 4, the diatom-bacterium symbiotic organic liquid fertilizer prepared by the present disclosure could improve soil contaminated by sewage separated from livestock and poultry manure, fruit and vegetable pressing wastewater, or vegetable waste pressing wastewater to significantly increase rice yield.

The above results prove that the diatom-bacterium symbiotic organic liquid fertilizer prepared in the present disclosure can effectively improve soil pollution, enhance fertilizer utilization, increase crop yield and quality, as well as realize resource utilization of waste.

The above examples are only intended to describe the preferred implementations of the present disclosure, but not to limit the scope of the present disclosure. Various alterations and improvements made by those of ordinary skill in the art based on the technical solution of the present disclosure without departing from the design spirit of the present disclosure shall fall within the scope of the appended claims of the present disclosure.

What is claimed is:

1. A preparation method of a diatom-bacterium symbiotic organic liquid fertilizer, comprising the following steps:
(1) mixing a compound bacterial powder with a waste liquid organic matter to allow first fermentation to obtain a small-molecule organic liquid fertilizer;
(2) mixing diatom with the small-molecule organic liquid fertilizer to allow second fermentation to obtain a bio-organic fertilizer; and
(3) mixing a microbial inoculant with the bio-organic fertilizer to allow third fermentation to obtain the diatom-bacterium symbiotic organic liquid fertilizer.

2. The preparation method according to claim 1, wherein the compound bacterial powder comprises Thiobacillus denitrificans, Bacillus megaterium, Alcaligenes faecalis, and Issatchenkia orientalis, and the waste liquid organic matter is selected from the group consisting of sewage separated from livestock and poultry manure, fruit and vegetable pressing wastewater, and vegetable waste pressing wastewater in step (1).

3. The preparation method according to claim 2, wherein the compound bacterial powder and the waste liquid organic matter are at a mass ratio of (1-3):(48-65), and the Thiobacillus denitrificans, the Bacillus megaterium, the Alcaligenes faecalis, and the Issatchenkia orientalis are at a mass ratio of (10-15):(6-8):(8-10):(1-3) in step (1).

4. The preparation method according to claim 1, wherein the diatom and the small-molecule organic liquid fertilizer in step (2) are at a mass ratio of (1-3):(55-75).

5. The preparation method according to claim 1, wherein the microbial inoculant in step (3) comprises Bacillus amyloliquefaciens, Brevibacillus laterosporus, and Streptomyces microflavus.

6. The preparation method according to claim 5, wherein the microbial inoculant and the bio-organic fertilizer are at a mass ratio of (1-3):(62-84), and the Bacillus amyloliquefaciens, the Brevibacillus laterosporus, and the Streptomyces microflavus in the microbial inoculant are at a mass ratio of (8-11):(7-10):(2-4) in step (3).

7. The preparation method according to claim 1, wherein the first fermentation in step (1) is conducted with a pH value of 6.8 to 7.2 at 25° C. to 35° C. for 48 h to 96 h; the second fermentation in step (2) is conducted with a light intensity of 1,500 lux to 2,500 lux at 25° C. to 30° C. for 96 h to 128 h; and the third fermentation in step (3) is conducted at 25° C. to 35° C. for 24 h to 72 h.

8. A diatom-bacterium symbiotic liquid fertilizer prepared by the preparation method according to claim 1.

9. The diatom-bacterium symbiotic liquid fertilizer according to claim 8, wherein the compound bacterial powder comprises Thiobacillus denitrificans, Bacillus megaterium, Alcaligenes faecalis, and Issatchenkia orientalis, and the waste liquid organic matter is selected from the group consisting of sewage separated from livestock and poultry manure, fruit and vegetable pressing wastewater, and vegetable waste pressing wastewater in step (1).

10. The diatom-bacterium symbiotic liquid fertilizer according to claim 9, wherein the compound bacterial powder and the waste liquid organic matter are at a mass ratio of (1-3):(48-65), and the Thiobacillus denitrificans, the Bacillus megaterium, the Alcaligenes faecalis, and the Issatchenkia orientalis are at a mass ratio of (10-15):(6-8):(8-10):(1-3) in step (1).

11. The diatom-bacterium symbiotic liquid fertilizer according to claim 8, wherein the diatom and the small-molecule organic liquid fertilizer in step (2) are at a mass ratio of (1-3):(55-75).

12. The diatom-bacterium symbiotic liquid fertilizer according to claim 8, wherein the microbial inoculant in step (3) comprises Bacillus amyloliquefaciens, Brevibacillus laterosporus, and Streptomyces microflavus.

13. The diatom-bacterium symbiotic liquid fertilizer according to claim 12, wherein the microbial inoculant and the bio-organic fertilizer are at a mass ratio of (1-3):(62-84), and the Bacillus amyloliquefaciens, the Brevibacillus laterosporus, and the Streptomyces microflavus in the microbial inoculant are at a mass ratio of (8-11):(7-10):(2-4) in step (3).

14. The diatom-bacterium symbiotic liquid fertilizer according to claim 8, wherein the first fermentation in step (1) is conducted with a pH value of 6.8 to 7.2 at 25° C. to 35° C. for 48 h to 96 h; the second fermentation in step (2) is conducted with a light intensity of 1,500 lux to 2,500 lux at 25° C. to 30° C. for 96 h to 128 h; and the third fermentation in step (3) is conducted at 25° C. to 35° C. for 24 h to 72 h.
